(19) United States
(12) Patent Application Publication
(10) Pub. No.: US 2020/0200040 A1
(43) Pub. Date: Jun. 25, 2020

(54) AIRCRAFT SURFACE COOLER ASSEMBLY

(71) Applicant: Unison Industries, LLC, Jacksonville, FL (US)

(72) Inventors: Hua Jiang, Dayton, OH (US); Anthony Lynn Lighthill, Springboro, OH (US); James Michael Moore, Dayton, OH (US); Walter Arthur Hundley, JR., Enon, OH (US); Ricardo Arturo Gutierrez Espinosa, El Marques (MX); Bernard Albert Luschek, Lebanon, OH (US); Dennis Alan McQueen, Miamisburg, OH (US); Derek Thomas Dreischarf, Bellbrook, OH (US); Michael Ralph Storage, Beavercreek, OH (US)

(21) Appl. No.: 16/225,075

(22) Filed: Dec. 19, 2018

(51) Int. Cl. F01D 25/14; B64D 33/02; F02K 3/06

(52) U.S. Cl. CPC F01D 25/14; F02C 3/06; F02K 3/06; B64D 33/02

(57) ABSTRACT

A surface cooler having a first cooling passage section configured to be operably coupled to a fan casing of an aircraft engine, the cooling passage section having a heat exchanger body defining a first distal end and a second distal end and having a set of fluid passages internal to the heat exchanger body and a first set of fins located on a first exterior surface of the heat exchanger body and a manifold operably coupled to a first distal end of the cooling passage section and wherein the manifold includes a manifold body having an interior fluidly coupled to at least one of the set of fluid passages and a second set of fins located on the manifold body to define a finned manifold and a method for forming same.

### BACKGROUND

Contemporary engines used in aircraft produce substantial amounts of heat that must be transferred away from the engine. Heat exchangers provide a way to transfer heat away from such engines. For example, heat exchangers can be arranged in a ring about a portion of the engine.

### BRIEF DESCRIPTION

An aspect of the disclosure relates to a surface cooler including a first cooling passage section configured to be operably coupled to a fan casing of an aircraft engine, the cooling passage section having a heat exchanger body defining a first distal end and a second distal end and having a set of fluid passages internal to the heat exchanger body and a first set of fins located on a first exterior surface of the heat exchanger body and a manifold operably coupled to a first distal end of the cooling passage section and wherein the manifold includes a manifold body having an interior fluidly coupled to at least one of the set of fluid passages and a second set of fins located on the manifold body to define a finned manifold.

Another aspect relates to a method of forming a surface cooler, the method including extruding a cooling passage section configured to be operably coupled to a fan casing of an aircraft engine, the cooling passage section having a heat exchanger body defining a first distal end and a second distal end and having a set of fluid passages internal to the body, forming a first set of fins located on a first exterior surface of the heat exchanger body, forming a manifold having a manifold body having an interior and a second set of fins located on the manifold body, and fluidly coupling the interior of the manifold body and at least one of the set of fluid passages of the heat exchanger body.

### BRIEF DESCRIPTION OF THE DRAWINGS

In the drawings:

FIG. 1 is an axial view of a surface cooler according to the prior art.

FIG. 2 is a schematic partially cut away view of a turbine engine assembly with a surface cooler and mounting system according to aspects of the present disclosure.

FIG. 3 is an axial view of a surface cooler that can be included in the turbine engine assembly of FIG. 2.

FIG. 4 is perspective view of a portion of the surface cooler FIG. 3.

FIG. 5 is perspective view of another portion of the surface cooler FIG. 3.

### DETAILED DESCRIPTION

One type of heat exchanger used in an aircraft engine is a surface cooler that is mounted to an aft fan casing. A typical surface cooler has three sections: a manifold section, a cooling passage heat exchanger section, and a return manifold. Conventional surface coolers have fins only on the cooling passage heat exchanger section. The conventional surface cooler inlet/outlet manifolds serve the single purpose of delivering oil to the finned cooling passage heat exchanger sections. Similarly, the conventional return manifolds only serve the single purpose of routing oil from one direction to another within the cooling passage heat exchanger section. As fins are not located on the inlet/outlet manifold or the return manifold, fins are only located on a fraction of the overall length of the surface cooler. Further still, the space in this region of the engine is limited and current designs utilize nearly all the available space. As a result, newer engine technologies, which have more heat that will be dissipated, will be thermally constrained due to the lack of surface cooler space available.

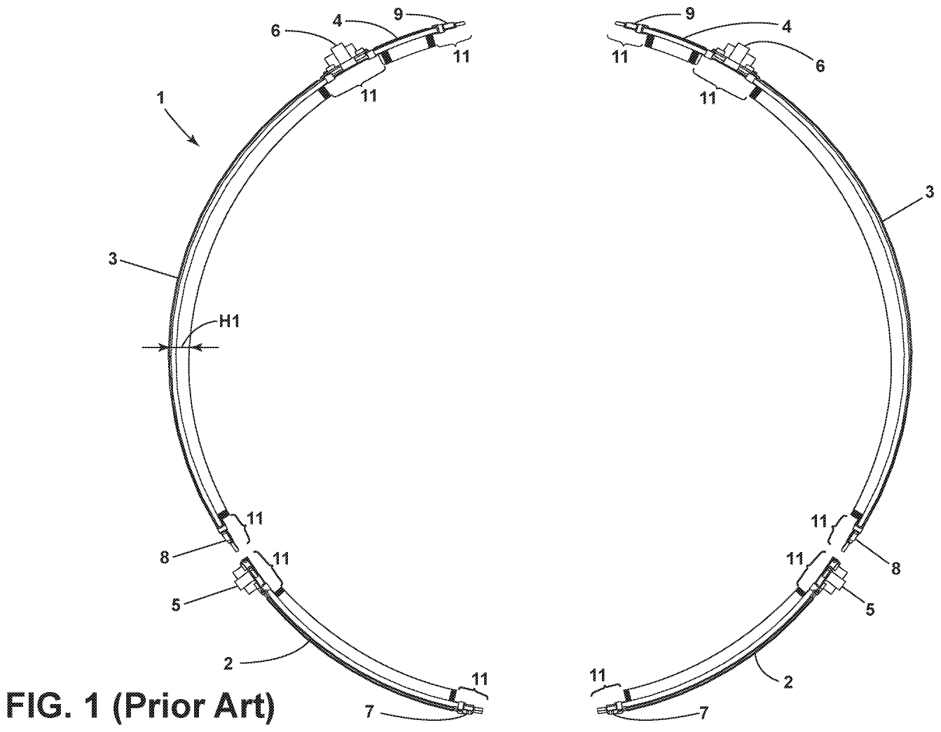

FIG. 1 illustrates a prior art annular surface cooler 1 that can be mounted about an aircraft engine (not shown). As illustrated the, prior art annular surface cooler 1 includes a first finned heat exchanger section 2, a second finned heat exchanger section 3, and a third finned heat exchanger section 4. The fins of such heat exchanger sections 2, 3, and 4 generally have a height of H1. Inlet/outlet manifolds 5 and 6 are operably couples to the first finned heat exchanger section 2, a second finned heat exchanger section 3, and a third finned heat exchanger section 4, respectively. A first return manifold 7 is coupled to the first finned heat exchanger section 2. A second return manifold 8 is coupled to the second finned heat exchanger section 3 and a third return manifold 9 is coupled to the third finned heat exchanger section 4. It will be understood that first finned heat exchanger section 2, second finned heat exchanger section 3, and third finned heat exchanger section 4 are the only finned portions of the prior art annular surface cooler 1. The un-finned portions are further called out as un-finned portions 11. In conventional surface coolers, such as the illustrated prior art surface cooler 1, only about 74% of the prior art surface cooler 1 is finned because the manifolds do not include finning.

Aspects of the present disclosure generally relate to surface cooler assemblies and more particularly to surface cooler assemblies with higher heat transfer, lower weight, and improved specific fuel consumption due to additional finned areas from current designs. For example, aspects of the present disclosure include fins on manifolds and return manifold sections of the surface cooler that have not previously been finned. In this manner, the manifolds become dual purpose and increase the effective heat transfer surface area of the surface cooler, which can then provide more efficient cooling.

Further, the term “surface coolers” as used herein can be used interchangeably with the term “heat exchangers.” As used herein, the surface coolers are applicable to various types of applications such as, but not limited to, turbojets, turbo fans, turbo propulsion engines, aircraft engines, gas turbines, steam turbines, wind turbines, and water turbines. While “a set of” various elements will be described, it will be understood that “a set” can include any number of the respective elements, including only one element. As used herein, the terms “axial” or “axially” refer to a dimension along a longitudinal axis of a component or along a longitudinal axis of the component. All directional references (e.g., radial, axial, upper, lower, upward, downward, left, right, lateral, front, back, top, bottom, above, below, vertical, horizontal, clockwise, counterclockwise) are only used for identification purposes to aid the reader's understanding of the disclosure, and do not create limitations, particularly as to the position, orientation, or use thereof. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order, and relative sizes reflected in the drawings attached hereto can vary.

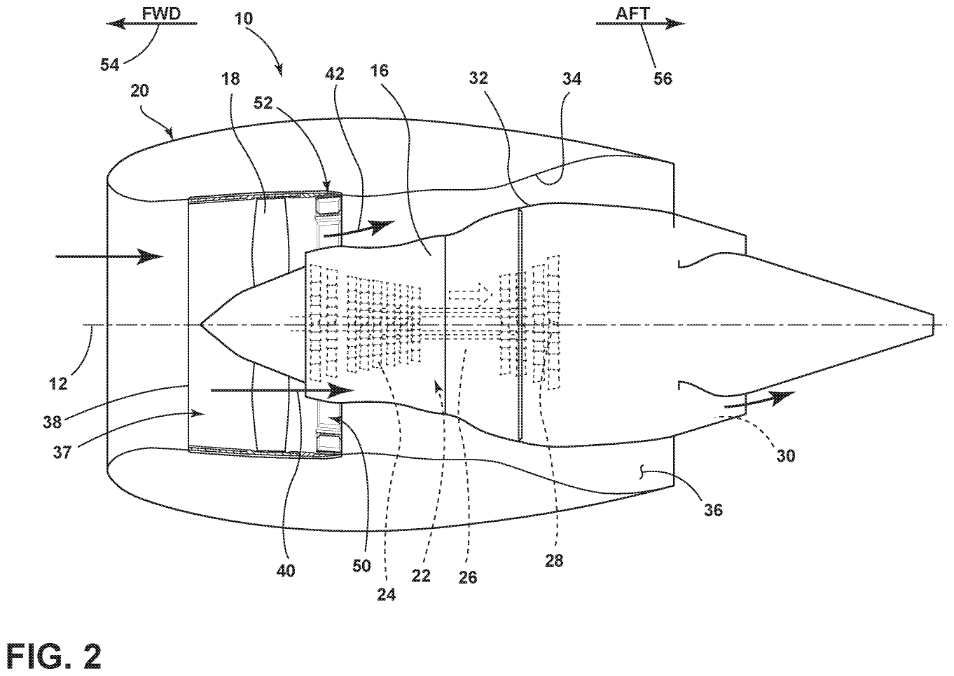

Referring to FIG. 2, a brief explanation of the environment in which aspects of the present disclosure can be used is described. More specifically, FIG. 2 illustrates an exemplary turbine engine assembly 10 having a longitudinal axis 12. A turbine engine 16, a fan assembly 18, and a nacelle 20 can be included in the turbine engine assembly 10. The turbine engine 16 can include an engine core 22 having compressor(s) 24, combustion section 26, turbine(s) 28, and exhaust 30. An inner cowl 32 radially surrounds the engine core 22.

Portions of the nacelle 20 have been cut away for clarity. The nacelle 20 surrounds the turbine engine 16 including the inner cowl 32. In this manner, the nacelle 20 forms an outer cowl 34 radially surrounding the inner cowl 32. The outer cowl 34 is spaced from the inner cowl 32 to form an annular passage 36 between the inner cowl 32 and the outer cowl 34. The annular passage 36 characterizes, forms, or otherwise defines a nozzle and a generally forward-to-aft bypass airflow path. A fan casing 37 having an annular forward casing 38 and an annular aft casing 52 can form a portion of the outer cowl 34 formed by the nacelle 20 or can be suspended from portions of the nacelle 20 via struts (not shown).

In operation, air flows through the fan assembly 18 and a first portion 40 of the airflow is channeled through compressor(s) 24 wherein the airflow is further compressed and delivered to the combustion section 26. Hot products of combustion (not shown) from the combustion section 26 are utilized to drive turbine(s) 28 and thus produce engine thrust. The annular passage 36 is utilized to bypass a second portion 42 of the airflow discharged from fan assembly 18 around engine core 22.

The turbine engine assembly 10 can pose unique thermal management challenges and a heat exchanger or surface cooler 50 can be attached to the turbine engine assembly 10 to aid in the dissipation of heat. The surface cooler 50 is an annular surface cooler that can be operably coupled to an annular aft casing 52 that forms an interior portion of the outer cowl 34. The surface cooler 50 can include, but is not limited to, an air-cooled oil-cooler heat exchanger that is positioned within the annular passage 36. While the surface cooler 50 has been illustrated as being downstream of the fan assembly 18 it is also contemplated that the surface cooler 50 can alternatively be upstream from fan assembly 18. As such, it will be understood that the surface cooler 50 can be positioned anywhere along the axial length of the annular passage 36. A forward direction, indicated by arrow 54, and an aft direction, as indicated by arrow 56 have been included for reference.

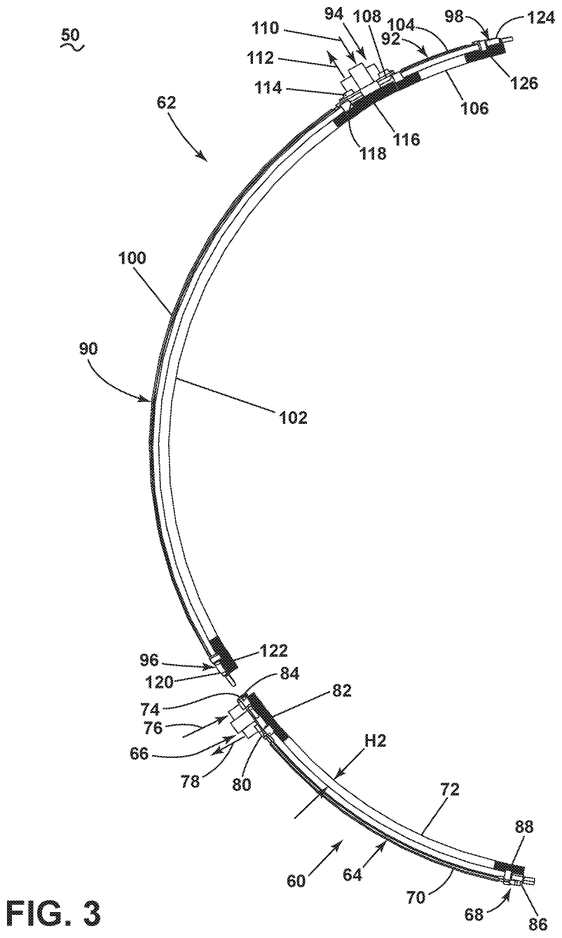

FIG. 3 illustrates a portion of the surface cooler 50 according to aspects of the present disclosure in more detail. It will be understood that only half of an annular configuration is shown here and that duplicative parts are not shown. An generator surface cooler 60 configured for cooling oil related to an integrated drive generator (not shown) and an engine lube oil surface cooler 62 configured for cooling lubrication oil of the aircraft engine are included in the surface cooler 50. Again, because only half of an annular configuration is shown it will be understood that the surface cooler 50 actually includes two IDG surface coolers 60 and two lube surface coolers 62. All of which are configured to keep oil within its respective system within functional predetermined limits thereof.

A first finned heat exchanger section or IDG cooling passage section 64, an IDG inlet/outlet manifold 66, and an IDG return manifold 68 are illustrated as being included in the IDG surface cooler 60. The IDG cooling passage section 64 includes a body 70 having fluid passages (not illustrated) and fins 72. A first manifold body 74 forms a portion of the IDG inlet/outlet manifold 66 and includes an IDG inlet 76 and an IDG outlet 78 (schematically illustrated with arrows) located on a first side 80 of the first manifold body 74. Fins 82 are located on a second side 84 of the first manifold body 74. Further still, a second manifold body 86 forms the IDG return manifold 68, which also includes fins 88.

A second finned heat exchanger section or main lube cooling passage section 90, a third finned heat exchanger section or secondary lube cooling passage section 92, a lube inlet/outlet manifold 94, a first lube return manifold 96, and a second lube return manifold 98 are illustrated as being included in the lube surface cooler 62. The main lube cooling passage section 90 includes a body 100 having fluid passages (not illustrated) and fins 102. The secondary lube cooling passage section 92 includes a body 104 having fluid passages (not illustrated) and fins 106.

A lube manifold body 108 forms a portion of the lube inlet/outlet manifold 94 and includes an lube inlet 110 and a lube outlet 112 (schematically illustrated with arrows) located on a first side 114 of the lube manifold body 108. Fins 116 are located on a second side 118 of the lube manifold body 108. The lube manifold body 108 fluidly couples to first distal ends of both the main lube cooling passage section 90 and the secondary lube cooling passage section 92.

A return body 120 having fins 122 forms the first lube return manifold 96 and is fluidly coupled to a second distal end of the main lube cooling passage section 90. Another return body 124 having fins 126 forms the second lube return manifold 98 and is fluidly coupled to a second distal end of the secondary lube cooling passage section 92.

Further still, while not illustrated it will be understood that the IDG inlet/outlet manifold 66 and the lube inlet/outlet manifold 94 can each include a valve fluidly coupled to one of the respective inlets or outlets to control the flow of fluid within the IDG surface cooler 60 and lube cooler 62. Such a valve can be any suitable type of valve including but not limited to a valve that can be a thermal valve configured to control a flow of fluid through the manifold body until a predetermined temperature of the fluid has been reached. Further still, mounting mechanisms can be associated with or operably coupled to the IDG surface cooler 60 and lube cooler 62 such that the IDG surface cooler 60 and lube cooler 62 can be operably coupled with the turbine engine assembly 10 (FIG. 2).

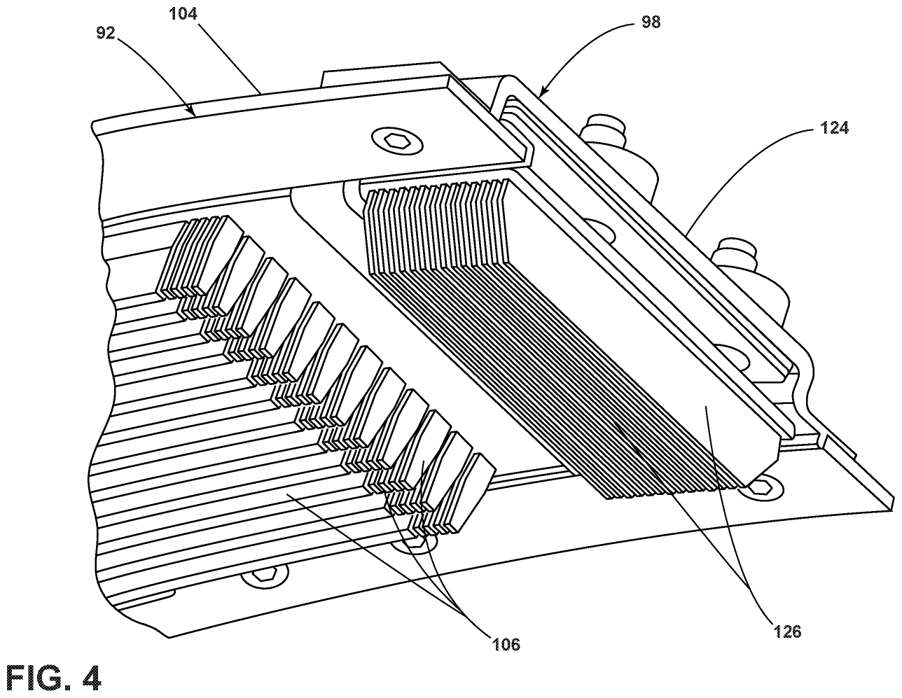

FIG. 4 also illustrates the second distal end of the secondary lube cooling passage section 92, which is operably coupled to the second lube return manifold 98. It will be understood that the secondary lube cooling passage section 92 can be formed in any suitable manner including that fluid passages (not illustrated) can be formed therein. For example, the body 104, including the fluid passages therein can be an extruded body including an extruded metal body such as aluminum, by way of non-limiting example.

A set of fins 106 are located on the body 104. It will be understood that while some of the fins 106 have been shown as being more discrete and some of the fins 106 have been shown as a longer solid body that any suitable type, size, profile, and shape are contemplated. Further still, the longer solid bodies have been included for clarity sake and it will be understood that only discrete fins can be included. In one non-limiting example, the fins 106 can include thin metal shavings skived from the body 104.

The return body 124 and its fins 126 are also illustrated more clearly. The secondary lube cooling passage section 92 and return body 124 can be coupled in any suitable manner including that they can be welded together (not shown).

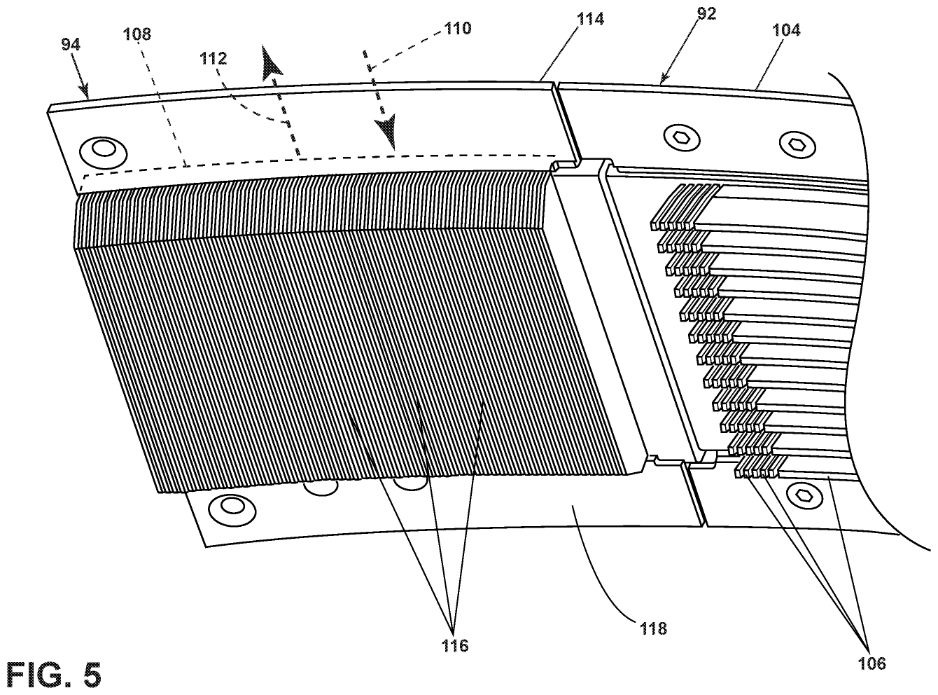

FIG. 5 better illustrates the fins 116 on the second side 118 of the lube manifold body 108, which forms a portion of the lube inlet/outlet manifold 94 and includes the lube inlet 110 and the lube outlet 112 (schematically illustrated with arrows) located on a first side 114 of the lube manifold body 108.

During operation, of the surface cooler 50 (FIG. 2) a hot fluid such as oil can be passed through IDG surface cooler 60 or the lube cooler 62. Both will be explained. During operation of the IDG surface cooler 60, hot oil can be introduced via the IDG inlet/outlet manifold 66, oil can then flow in a first direction through the IDG cooling passage section 64, be redirected by the IDG return manifold 68, pass in a second opposite direction through the IDG cooling passage section 64 and exit via the IDG inlet/outlet manifold 66. Heat from the oil may be conducted through the first manifold body 74 of the IDG inlet/outlet manifold 66, the body 70 of the IDG cooling passage section 64, and the second manifold body 86 of the IDG return manifold 68. The heat can dissipated from the bodies through the fins 72, or fins 88, respectively, to a cooling fluid passing by the fins 72, or fins 88. The cooling fluid can include, but is not limited to, cooling air passing through the annular passage 36, which by way of a non-limiting example can be a bypass duct of the turbine engine assembly 10.

During operation of the lube surface cooler 62, oil can be introduced via the lube inlet/outlet manifold 94, be passed through the first lube return manifold 96 or the second lube return manifold 98 and be returned via the first lube return manifold 96 or the second lube return manifold 98, respectively. Heat from the oil may be conducted through lube manifold body 108, main lube cooling passage section 90, secondary lube cooling passage section 92, return body 120 of the first lube return manifold 96 or return body 124 of the second lube return manifold 98. Heat can be dissipated from the bodies through the set of fins 110, fins 122, fins 126, or a combination thereof, respectively, to a cooling fluid passing by the fins 110, fins 122, and fins 126. It will be understood that in some cases the fluid flow to the first lube return manifold 96 and the second lube return manifold 98 can be selectively chosen such that oil does not need to flow through both sections at once.

It will be understood that the manifold with fins can be formed in any manner. By way of one non-limiting example, the IDG inlet/outlet manifold 66, IDG return manifold 68, lube inlet/outlet manifold 94, first lube return manifold 96, or the second lube return manifold 98 can be cast and the fins can be added to the castings via additive manufacturing. In this manner, the casting of the bodies could be out of a first material and the additively manufactured fins could be out of a second material that is different from that of the first material. Alternatively, the same material could be used for both. By way of still further non-limiting examples, finned manifolds could be developed from machinings or extrusions.

In the surface cooler 50 of FIG. 3, the IDG surface cooler 60 by way of non-limiting examples can have a longer overall finned length. Similarly, the combined finned length of the lube surface cooler 62 can also be longer with finned manifolds. Adding fins to the manifolds increases the finned area by at least 14%. It will be understood that when fins are added to the IDG inlet/outlet manifold 66, the IDG return manifold 68, the lube inlet/outlet manifold 94, the first lube return manifold 96, and the second lube return manifold 98 of the surface cooler 50, that the surface area for heat transfer on each of the manifold(s) increases significantly. By way of one non-limiting example, on the IDG inlet/outlet manifold 66 the surface area can be increased significantly, while only increasing the mass of the IDG inlet/outlet manifold 66 by a trivial amount. By way of another non-limiting example, on the lube inlet/outlet manifold 94 of the lube surface cooler 62 the surface area can be increased significantly, while only increasing the mass of the IDG inlet/outlet manifold 66 by a trivial amount. It will be understood that the measurements herein are examples and that other lengths and surface areas are contemplated. This greatly increases the ability of the manifold to absorb and dissipate, which can also be thought of as greatly increasing the heat rejection of the manifold. While the fins increase the weight of the manifold itself, the use of the fins 72, fins 88, fins 122, and fins 126 reduces the heat load on the IDG cooling passage section 64, the main lube cooling passage section 90, and the secondary lube cooling passage section 92. Thus, all the fins on the IDG cooling passage section 64, the main lube cooling passage section 90, and the secondary lube cooling passage section 92 can have a reduced height H2 as compared to the prior art fins resulting in overall weight and Specific Fuel Consumption (SFC) improvements. It is contemplated that H2 can be 25% less than H1 and that a fin density can also be reduced by 25% that of the prior art. It has been determined that the same required amount of heat transfer can be achieved with a 3% weight reduction. More importantly it has been determined that the Specific Fuel Consumption would be improved by 54%. Further still, the surface cooler may be able to have a reduced width or length as compared to previous or contemporary designs because of the increased heat transfer provided by the fins on the manifold sections.

To the extent not already described, the different features and structures of the various embodiments can be used in combination with each other as desired. That one feature is not illustrated in all of the embodiments is not meant to be construed that it cannot be, but is done for brevity of description. Thus, the various features of the different embodiments can be mixed and matched as desired to form new embodiments, whether or not the new embodiments are expressly described. All combinations or permutations of features described herein are covered by this disclosure.

Further, while the fins 72 of the IDG cooling passage section 64 and the fins 102 of the main lube cooling passage section 90 and the fins 106 of the secondary lube cooling passage section 92 have been generally illustrated as having the same height as each other. The height has been indicated as H2. It will alternatively, be understood that the fins 72 of the IDG cooling passage section 64, the fins 102 of the main lube cooling passage section 90, or the fins 106 of the secondary lube cooling passage section 92 can have differing heights. Regardless of the similarity or differences of the heights it will be understood that the height H2 can generally be less than the height H1 of the prior art as described further below. In another non-limiting aspect of the disclosure, the fin 72, 102, 106 density may be reduced in lieu of reduced fin 72, 102, 106 height, or a combination of fin 72, 102, 106 height and density.

Many other possible aspects and configurations in addition to that shown in the above figures are contemplated by the present disclosure. For example, aspects of FIGS. 4 and 5 illustrate different types of fins 106, 116, 126. In non-limiting aspects of the disclosure, the fins shown and described can be interchangeable or reconfigurable such that any number of combinations or permutations of features described herein are covered by this disclosure

This written description uses examples to disclose the invention, including the best mode, and also to enable any person skilled in the art to practice the invention, including making and using any devices or systems and performing any incorporated methods. The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A fan casing assembly, comprising:
an annular fan casing having peripheral wall;
an annular surface cooler operably coupled to the annular fan casing and having a first surface confronting the peripheral wall and a second surface opposite the first surface, the annular surface cooler, comprising:
a first cooling passage section configured to be operably coupled to the annular fan casing of an aircraft engine, the first cooling passage section having a heat exchanger body defining a first distal end and a second distal end and having a set of fluid passages internal to the heat exchanger body and a first set of fins located on a first exterior surface of the heat exchanger body; and
a manifold operably coupled to the first distal end of the first cooling passage section and wherein the manifold includes a manifold body having an interior fluidly coupled to at least one of the set of fluid passages and a second set of fins located on the manifold body to define a finned manifold.

2. The fan casing assembly of claim 1, further comprising a second manifold operably coupled to the second distal end of the first cooling passage section and wherein the second manifold includes a second manifold body having a second interior fluidly coupled to at least one of the set of fluid passages and a third set of fins located on the second manifold body.

3. The fan casing assembly of claim 2 wherein the finned manifold is a finned inlet/outlet manifold and the second manifold is a finned return manifold.

4. The fan casing assembly of claim 3 wherein the annular surface cooler is an air cooled oil cooler.

5. The fan casing assembly of claim 3 wherein the annular surface cooler includes at least one of an integrated drive generator surface cooler and a lube surface cooler.

6. The fan casing assembly of claim 5 wherein the annular surface cooler includes both the integrated drive generator surface cooler and the lube surface cooler, each having a first cooling passage section, a finned inlet/outlet manifold, and a finned return manifold.

7. The fan casing assembly of claim 6 wherein the lube surface cooler further comprises a third finned heat exchanger body having a set of internal fluid passages fluidly coupled to the finned inlet/outlet manifold at a first end.

8. The fan casing assembly of claim 7 wherein the lube surface cooler further comprises another finned return manifold coupled to a second end of the third finned heat exchanger body.

9. The fan casing assembly of claim 8 wherein the annular surface cooler with the finned manifolds and finned return manifolds provides for a substantially same heat transfer as an annular surface cooler having manifolds with no fins and the annular surface cooler with the finned manifolds has a reduced weight compared to the an annular surface cooler having manifolds with no fins.

10. The fan casing assembly of claim 8 wherein the annular surface cooler with the finned manifolds and finned return manifolds provides for a significant specific fuel consumption improvement improved by at least 20% as compared to an annular surface cooler having manifolds with no fins.

11. The fan casing assembly of claim 10 wherein the annular surface cooler with the finned manifolds and finned return manifolds provides for a specific fuel consumption improved by at least 50% as compared to an annular surface cooler having manifolds with no fins.

12. A surface cooler assembly, comprising:
a cooling passage section having a heat exchanger body defining a first distal end and a second distal end and having a set of fluid passages internal to the heat exchanger body and a first set of fins located on a first exterior surface of the heat exchanger body; and
a manifold operably coupled to the first distal end of the cooling passage section and wherein the manifold includes a manifold body having an interior fluidly coupled to at least one of the set of fluid passages and a second set of fins located exteriorly on the manifold body to define a finned manifold.

13. The annular surface cooler assembly of claim 12, further comprising a second manifold operably coupled to the second distal end of the cooling passage section and wherein the second manifold includes a second manifold body having a second interior fluidly coupled to at least one of the set of fluid passages and a third set of fins located on the second manifold body.

14. The annular surface cooler assembly of claim 13 wherein the finned manifold is a finned inlet/outlet manifold and the second manifold is a finned return manifold.

15. The annular surface cooler assembly of claim 14, further comprising as second finned heat exchanger body having a set of internal fluid passages fluidly coupled to the finned inlet/outlet manifold at a first end and further comprising a second finned return manifold operably coupled to the second finned heat exchanger body at a second end of the second finned heat exchanger body.

16. The annular surface cooler assembly of claim 13 wherein the surface cooler is an air cooled oil cooler.

17. A method of forming a surface cooler, the method comprising:
extruding a cooling passage section configured to be operably coupled to a fan casing of an aircraft engine, the cooling passage section having a heat exchanger body defining a first distal end and a second distal end and having a set of fluid passages internal to the heat exchanger body;
forming a first set of fins located on a first exterior surface of the heat exchanger body;
forming a manifold having a manifold body having an interior and a second set of fins located on the manifold body; and
fluidly coupling the interior of the manifold body and at least one of the set of fluid passages of the heat exchanger body.

18. The method of claim 17 wherein forming the manifold body comprises casting, machining, or extruding the manifold body.

19. The method of claim 18 wherein forming the second set of fins comprises additively manufacturing the second set of fins on the manifold body.

20. The method of claim 19 wherein the second set of fins is formed from a second material different from a first material of the manifold body.
